(19) United States
(12) Patent Application Publication
(10) Pub. No.: US 2025/0316726 A1
(43) Pub. Date: Oct. 9, 2025

(54) Fuel Cell System and Control Method Thereof

(71) Applicants: Hyundai Motor Company, Seoul (KR); Kia Corporation, Seoul (KR)

(72) Inventors: Seung Man Park, Anyang-Si (KR); Jae Kwan Bae, Seoul (KR); Ha Neul Lee, Seongnam-si (KR)

(21) Appl. No.: 18/810,846

(22) Filed: Aug. 21, 2024

(30) Foreign Application Priority Data
Apr. 9, 2024 (KR) 10-2024-0048190

(51) Int. Cl. H01M 8/04119; H01M 8/0432; H01M 8/0438; H01M 8/04492; H01M 8/04992

(52) U.S. Cl. CPC H01M 8/04156; H01M 8/04358; H01M 8/04388; H01M 8/04492; H01M 8/04992

(57) ABSTRACT

A fuel cell system includes a fuel cell stack, a drain valve connected to a side of an anode of the fuel cell stack, and a controller. The controller is configured to determine a drained water amount at the anode side of the fuel cell stack according to opening of the drain valve, and to control a hydrogen supply pressure supplied to the fuel cell stack by activating different pressure control functions in accordance with a result of comparison between the drained water amount and a predetermined required drain amount.

### CROSS-REFERENCE TO THE RELATED APPLICATION

This application claims priority from Korean Patent Application No. 10-2024-0048190 filed on Apr. 9, 2024 in the Korean Intellectual Property Office, the disclosure of which is incorporated herein by reference in its entirety.

### TECHNICAL FIELD

The present disclosure relates to a fuel cell system, configured to drain water present in a fuel cell stack, and a control method thereof.

### BACKGROUND

A fuel cell stack is a device configured to receive hydrogen and air (e.g., from an exterior of the fuel cell stack) and to generate electrical energy through a electrochemical reaction using the received hydrogen and air. Such a fuel cell stack may be used as a power source, such as in fuel cell electric vehicles (FCEVs), fuel cells for power generation, etc.

A fuel cell system includes a fuel cell stack including a plurality of stacked fuel cells to be used as a power source, a fuel supply system configured to supply a fuel, such as hydrogen, to the fuel cell stack, an air supply system configured to supply an oxidant, such as oxygen, required for electrochemical reaction, and a water and/or heat management system configured to control a temperature of the fuel cell stack, etc.

The fuel supply system may decompress compressed hydrogen stored in a hydrogen tank, and then supplies the decompressed hydrogen to an anode (fuel electrode) of the fuel cell stack. The air supply system draws in ambient air by operating an air compressor, and then supplies the drawn in air to a cathode (air electrode) of the fuel cell stack.

If hydrogen is supplied to the anode of the fuel cell stack, and oxygen is supplied to the cathode of the fuel cell stack, separation of hydrogen ions is carried out at the anode through catalyst reaction. Separated hydrogen ions are transferred to the cathode through an electrolyte membrane. At the cathode, the hydrogen ions separated at the anode electrochemically react with electrons and oxygen and, as such, electrical energy may be obtained.

Water is produced due to the above-mentioned electrochemical reaction of the fuel cell stack. To this end, the fuel cell system is equipped with a drainage device configured to drain the water produced in the fuel cell stack. The fuel cell system outwardly drains water present in an interior of the fuel cell stack by operating the drainage device.

However, a part of the produced water may be introduced into the side of the anode after passing through the electrolyte membrane due to a concentration difference at opposite sides of the electrolyte membrane. For this reason, degradation of the fuel cell stack may be accelerated unless the produced water introduced into the anode side is efficiently drained in time. Therefore, it is necessary to manage the produced water in order to prevent degradation of the fuel cell stack and, as such, to secure durability of the fuel cell stack.

The above matters disclosed in this section are merely for enhancement of understanding of the general background of the disclosure and should not be taken as an acknowledgement or any form of suggestion that the matters form the related art already known to a person skilled in the art.

### SUMMARY

The following summary presents a simplified summary of certain features. The summary is not an extensive overview and is not intended to identify key or critical elements.

Systems, apparatuses, and methods are described for a fuel cell system. A fuel cell system may comprise a fuel cell stack, a drain valve connected to an anode of the fuel cell stack, and a controller. The controller may be configured to determine a drained water amount of water drained, via an opening of the drain valve, from the anode of the fuel cell stack; and control, by activating, based on a comparison between the drained water amount and a predetermined required drain amount, one or more pressure control functions, a hydrogen supply pressure to the fuel cell stack.

A control method of a fuel cell system may comprise determining a drained water amount of water drained from an anode side of a fuel cell stack, comparing the drained water amount with a predetermined required drain amount, and controlling, by activating, based on the comparing the drained water amount with the required drain amount, one or more pressure control functions, a hydrogen supply pressure supplied to the fuel cell stack.

These and other features and advantages are described in greater detail below.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a block diagram showing a configuration of a fuel cell system according to an example of the present disclosure;

FIG. 2 and FIG. 3 are views showing control of a hydrogen supply pressure according to an example of the present disclosure; and

FIG. 4 is a flowchart explaining a control method of a fuel cell system according an example of the present disclosure.

### DETAILED DESCRIPTION

In the following description, a detailed description of known functions and configurations incorporated herein will be omitted if such a description would obscure the subject matter of the examples of the present disclosure. In addition, the examples of the present disclosure will be more clearly understood from the accompanying drawings and should not be limited by the accompanying drawings, and it is to be appreciated that all changes, equivalents, and substitutes that do not depart from the spirit and technical scope of the present disclosure are encompassed in the present disclosure.

It will be understood that, although the terms “first”, “second”, etc. may be used herein to describe various elements, these elements should not be limited by these terms. These terms are only used to distinguish one element from another.

In the case where an element is “connected” or “linked” to another element, it should be understood that the element may be directly connected or linked to the other element, or another element may be present therebetween. Conversely, in the case where an element is “directly connected” or “directly linked” to another element, it should be understood that no other element is present therebetween.

Unless clearly used otherwise, singular expressions include a plural meaning.

In this specification, the term “comprising”, “including”, or the like, is intended to express the existence of the characteristic, the numeral, the step, the operation, the element, the part, or the combination thereof, and does not exclude another characteristic, numeral, step, operation, element, part, or any combination thereof, or any addition thereto.

In addition, the term “unit” or “control unit” used in specific terminology such as a motor control unit (MCU), a hybrid control unit (HCU) or the like is only a term widely used for designation of a controller for controlling a particular function of a vehicle and, as such, does not mean a generic functional unit.

The controller may include a communication device configured to communicate with another controller or a sensor for control of a function to be performed thereby, a memory configured to store an operating system, logic commands, input/output information, etc., and at least one processor configured to execute discrimination, calculation, determination, etc. required for control of the function to be performed.

Hereinafter, examples of the present disclosure will be described in detail with reference to the accompanying drawings. The same or similar elements are designated by the same reference numerals regardless of the numerals in the drawings and redundant description thereof will be omitted.

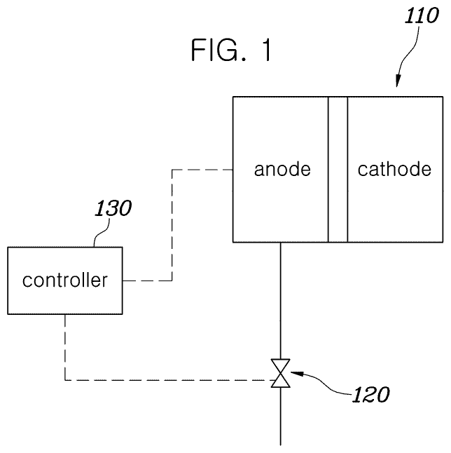

A fuel cell system according to an example of the present disclosure will be described with reference to FIG. 1.

FIG. 1 is a block diagram showing a configuration of the fuel cell system according to the example of the present disclosure.

The fuel cell system may include a fuel cell stack 110, a drain valve 120, and a controller 130. FIG. 1 mainly shows constituent elements associated with the example of the present disclosure, and, in practical cases, the fuel cell system may be implemented to include a greater or smaller number of constituent elements than that of the shown case.

An anode and a cathode may be provided at the fuel cell stack 110. The drain valve 120 may be connected to a side of the anode of the fuel cell stack 110.

In the fuel cell stack 110, hydrogen gas (e.g., remaining after electrochemical reaction of hydrogen and oxygen) and water produced due to the electrochemical reaction may be present. The remaining hydrogen gas and the produced water may be periodically drained/released/expelled to an exterior of the fuel cell system. For example, the hydrogen gas remaining after reaction may be drained from the anode side of the fuel cell stack 110 through the drain valve 120. At least some (e.g., a part) of the water produced at the side of the cathode of the fuel cell stack 110 may move to the anode due to a concentration difference in an interior of the fuel cell stack 110. The produced water moved to the anode may also be drained through the drain valve 120.

The controller 130 may control the drain valve 120 to drain the produced water moved from the cathode side of the fuel cell stack 110 to the anode side of the fuel cell stack 110. However, unless the produced water present at the anode side of the fuel cell stack 110 is drained in an appropriate amount, performance degradation of the fuel cell stack 110 may be accelerated due to residue of the produced water at the anode side of the fuel cell stack 110. If the fuel cell stack 110 is in a humidified state, drain of the produced water present at the anode side may be inefficiently carried out. The produced water may remain at the anode side of the fuel cell stack 110. As a result, due to residue of the produced water at the anode side of the fuel cell stack 110, an abnormal/undesired phenomenon, such as loss of a catalyst (for example, platinum) present at the anode side or corrosion of an electrode support (for example, carbon), may occur, thereby accelerating performance degradation of the fuel cell stack 110.

In order to prevent acceleration of performance degradation of the fuel cell stack 110, and to solve other problems, the controller 130 may check whether or not water present at the anode side of the fuel cell stack 110 (the part of produced water moved from the cathode side to the anode side) has been drained in an appropriate amount. The controller 130 may control a supply pressure of hydrogen supplied to the fuel cell stack 110 in order to enable the water at the anode side to be drained in an appropriate amount if the water at the anode side has not been drained in an appropriate amount.

In more detail, the controller 130 may determine a drain amount of water drained from the anode side of the fuel cell stack 110 in accordance with (e.g., based on) opening of the drain valve 120. A flow sensor (e.g., flowmeter, not shown) configured to measure an amount of water present in and/or flowing from the interior of the fuel cell stack 110 may be provided at the fuel cell system. The controller 130 may collect data sensed from the flow sensor, and may determine a drain amount of water drained from the anode side of the fuel cell stack 110 based on the collected data. This is only illustrative and, as such, the present disclosure is not limited thereto. For example, the controller 130 may collect sensing data from a sensor provided at an anode outlet side of the fuel cell stack 110, and may determine an amount of drained water (a drained water amount) based on the collected sensing data from the sensor at the anode outlet side of the fuel cell stack 110.

Also, or alternatively, the controller 130 may control a supply pressure of hydrogen supplied to the fuel cell stack 110 in accordance with a result of comparison between the determined drained water amount and a predetermined required drain amount. The predetermined required drain amount may mean an amount of water to be drained from the anode side of the fuel cell stack 110 in order to prevent degradation of the fuel cell stack 110. For example, the predetermined required drain amount may be set to an amount of water crossing over to the anode side of the fuel cell stack 110 from a total amount of water produced in the fuel cell stack 110, based on a state of the fuel cell stack 110 (e.g., how much water has been drained from the fuel cell stack 110 and how much water has been produced in the fuel cell stack 110). This is only illustrative and, as such, the present disclosure is not limited thereto.

Also, or alternatively, the controller 130 may determine an internal resistance of the fuel cell stack 110. For example, the controller 130 may determine a current flowing in the fuel cell stack 110 via electrochemical impedance spectroscopy (EIS). the controller 130 may determine an internal resistance of the fuel cell stack 110 based on the determined current. This is only illustrative and, as such, the present disclosure is not limited thereto. Any other sensor/device for determining the internal resistance may be used

Also, or alternatively, the controller 130 may determine a state of the fuel cell stack 110 based on a result of comparison between the drained water amount and the required drain amount and/or a result of comparison between the determined internal resistance and a predetermined first reference internal resistance. The controller 130 may control a hydrogen supply pressure by activating different pressure control functions in accordance with the determined state of the fuel cell stack 110. The determined state of the fuel cell stack 110 may mean a flooded state or a dry state of the fuel cell stack 110. Also, or alternatively, the internal resistance may be a charge transfer resistance or an ohmic resistance. The first reference internal resistance according to the example of the present disclosure may be an internal resistance at which a flooding phenomenon occurs in the fuel cell stack 110, that is, a charge transfer resistance. Also, or alternatively, the first reference internal resistance according to the example of the present disclosure may be a value set to a product of an internal resistance of the fuel cell stack 110 in a normal state multiplied with an internal resistance increase rate (for example, 1.3) of the fuel cell stack 110 in a flooded state (e.g., if a flooding phenomenon occurs in the fuel cell stack 110). However, this is only illustrative and, as such, the present disclosure is not limited thereto.

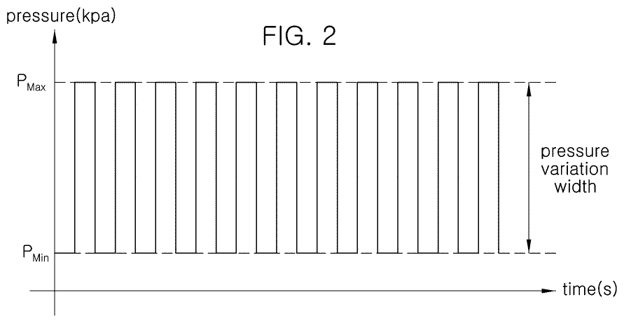

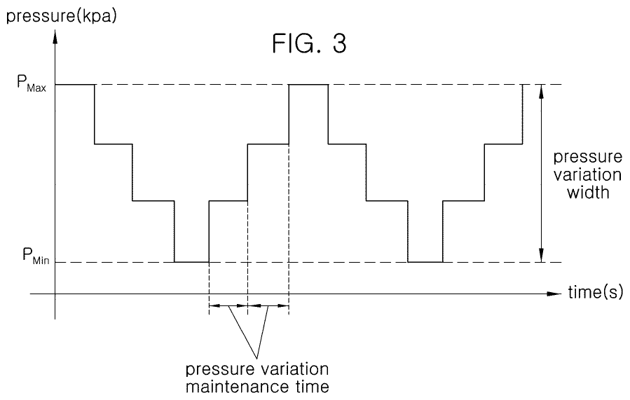

For example, the controller 130 may determine that the fuel cell stack 110 is in a flooded state, if the drained water amount is less than the required drain amount and the determined internal resistance is not less than the first reference internal resistance. If the fuel cell stack 110 is in the flooded state, it may be necessary to remove water present at the anode side of the fuel cell stack 110. The controller 130 may control a hydrogen supply pressure by activating a first pressure control function that changes a pressure in stages but has a pressure variation maintenance time each time the pressure is changed. This will be described hereinafter with reference to FIG. 2 and FIG. 3.

FIG. 2 and FIG. 3 are views explaining control of a hydrogen supply pressure according to an example of the present disclosure.

FIG. 2 shows a conventional case of varying hydrogen supply pressure in a fuel cell stack. A pressure range having a maximum pressure value PMax and a minimum pressure value PMin is set based on a target pressure and a pressure variation width, for example. Water remaining at the anode side of the fuel cell stack 110 is drained under the condition that a hydrogen supply pressure is varied rapidly over time at a frequency, based on the set pressure range. However, as variation of the hydrogen supply pressure is rapidly carried out, there may be problems in that diffusion of hydrogen is more effectively carried out than drain of water, and noise caused by airflow sound is excessively generated in the fuel cell stack 110.

To this end, the controller 130 according to the example of the present disclosure may control a hydrogen supply pressure by activating the first pressure control function that changes a pressure in stages but has a pressure variation maintenance time each time the pressure is changed, as shown in FIG. 3, if additional water drainage from the interior of the fuel cell stack 110 is required.

FIG. 3 shows a graph depicting control of a hydrogen supply pressure if the first pressure control function according to the example of the present disclosure is activated. Referring to FIG. 3, a pressure range having a maximum pressure value PMax and a minimum pressure value PMin may be set based on a target pressure and a pressure variation width. Also, or alternatively, the controller 130 may control a hydrogen supply pressure based on the set pressure range under the condition that the hydrogen supply pressure is stepwise increased from the minimum pressure value PMin to a maximum pressure value PMax in a plurality of divided durations, without being increased at once, as was the case in the situation described with reference to FIG. 2. Also, or alternatively, every time the hydrogen supply pressure is increased in each of the plurality of divided durations, the controller 130 may control the increased pressure to be maintained for the pressure variation maintenance time. This control method may be similarly applied by the controller 130 to decrease the hydrogen supply pressure from the maximum pressure value PMax and the minimum pressure value PMin.

If additional water drainage from the interior of the fuel cell stack 110 is required, the controller 130 may secure a time for hydrogen to diffuse and flow inside the fuel cell stack 110 by controlling the hydrogen supply pressure via activation of the first pressure control function that changes a pressure in stages but has a pressure variation maintenance time each time the pressure is changed. Accordingly, a continuous flow of hydrogen in a desired direction may be generated and, as such, an increase in flow rate of hydrogen may be achieved. As a result, it may be possible to enhance drainage of water at the anode side of the fuel cell stack 110 and to prevent excessive generation of noise caused by airflow sound.

Referring to FIG. 1 again, if the fuel cell stack 110 is in the flooded state, the controller 130 may control the hydrogen supply pressure by activating the first pressure control function, in order to remove water present at the anode side of the fuel cell stack 110. If the first pressure control function is activated, the hydrogen supply pressure may be controlled to correspond to FIG. 3.

As above, the amount of water produced in the fuel cell stack 110 may be varied based on various conditions, such as an operating area and/or an operating temperature of the fuel cell stack. Also, or alternatively the required drain amount of water to be drained from the anode side of the fuel cell stack 110 may be varied in accordance with various conditions such as an operating area and/or an operating temperature of the fuel cell stack 110. To this end, the controller 130 may differentially control the hydrogen supply pressure, taking into consideration various conditions of the fuel cell stack 110 while removing water present at the anode side of the fuel cell stack 110 by activating the first pressure control function.

In detail, if the first pressure control function is activated, the controller 130 may determine a temperature of cooling water discharged from the fuel cell stack 110. A temperature sensor (not shown) configured to measure a temperature of cooling water flowing through the fuel cell stack 110 may be provided in the fuel cell system. The controller 130 may receive sensed temperature information from the temperature sensor, thereby determining a temperature of cooling water discharged from the fuel cell stack 110. This is only illustrative and, as such, the present disclosure is not limited thereto.

Also, or alternatively, the controller 130 may control the hydrogen supply pressure such that the hydrogen supply pressure is differentially controlled by differentially setting a control condition according to activation of the first pressure control function, based on the determined cooling water temperature.

For example, if the temperature of the cooling water satisfies (e.g., is less than) a predetermined first reference temperature, the controller 130 may control the hydrogen supply pressure by setting a first control condition that the pressure variation width of the hydrogen supply pressure is set to a first reference width and a supply flow rate acceleration of hydrogen supplied to the fuel cell stack 110 is set to a first acceleration.

If the temperature of the cooling water does not satisfy (e.g., is not less than) the predetermined first reference temperature, but satisfies (e.g., is less than) a predetermined second reference temperature (e.g., higher than the predetermined first reference temperature), the controller 130 may control the hydrogen supply pressure by setting a second control condition that the pressure variation width of the hydrogen supply pressure is set to a second reference width and the supply flow rate acceleration of hydrogen supplied to the fuel cell stack 110 is set to a second acceleration.

If the operating temperature of the fuel cell stack 110 is low due to a low temperature of the cooling water, a larger amount of water may remain at the anode side of the fuel cell stack 110. Accordingly, a larger amount of water should be drained (e.g., based on the temperature of the cooling water being low). To this end, the controller 130 may strengthen the first control condition set (e.g., based on the cooling water temperature being less than the predetermined first reference temperature) such that parameters of the first control condition are greater than those of the second control condition set (which may correspond to the cooling water temperature not being less than the predetermined first reference temperature, but less than the predetermined second reference temperature). For example, the first reference width (a pressure variation width according to the first control condition) may be set to be greater than the second reference width (a second pressure variation width according to the second control condition), and the first acceleration according to the first control condition may be set to be greater than the second acceleration according to the second control condition.

For example, the second acceleration according to the second control condition may be a value corresponding to a predetermined reference acceleration. The reference acceleration may be a minimum acceleration at which water drainage from the anode side of the fuel cell stack 110 is induced based on a pressure increase according to activation of the first pressure control function. Accordingly, the first acceleration according to the first control condition may be set to a value obtained based on a first correction value applied to the predetermine reference acceleration, such that the first acceleration is greater than the second acceleration. Here, the first correction value may mean a ratio of an amount of water crossing over from the cathode side to the anode side of the fuel cell stack 110 to a water drain amount determined in accordance with opening of the drain valve 120. This is only illustrative and, as such, the present disclosure is not limited thereto.

If the determined cooling water temperature does not satisfy (e.g., is not less than) the predetermined second reference temperature, a state change from the flooded state to a dry state may occur in the fuel cell stack 110 due to overheating. To this end, the controller 130 may determine whether or not a state change of the fuel cell stack 110 occurs based on the temperature of the cooling water not satisfying (not being less than) the second reference temperature.

The controller 130 may determine (e.g., re-determine) an internal resistance of the fuel cell stack 110 if the temperature of the cooling water does not satisfy (e.g., is not less than) the second reference temperature. The controller 130 may then compare the re-determined internal resistance with a predetermined second reference internal resistance. If the re-determined internal resistance is not less than a predetermined second reference internal resistance, the controller 130 may determine that a state change of the fuel cell stack 110 has occurred. Here, the second reference internal resistance may mean a reference internal resistance set in accordance with existing degradation aspects of the fuel cell stack 110. The second reference internal resistance may be a value set by reflecting a second correction value in a moving average value of the internal resistance according to the existing degradation aspects of the fuel cell stack 10. For example, the moving average value may mean an average value calculated based on a plurality of sampled internal resistance values obtained by sampling a plurality of internal resistance values according to the existing degradation aspects, and the second correction value may mean an internal resistance increase coefficient caused by degradation of a material in the fuel cell stack 110 according to the existing degradation aspects of the fuel cell stack 110. These are only illustrative and, as such, the present disclosure is not limited thereto.

If the re-determined internal resistance is less than the predetermined second reference internal resistance, the controller 130 determines that no state change of the fuel cell stack 110 has occurred. If no state change of the fuel cell stack 110 has occurred, the second control condition according to activation of the first pressure control function may be set to control a hydrogen supply pressure. For example, if no state change of the fuel cell stack 110 has occurred, the controller 130 may activate the first pressure control function, thereby setting the second control condition that the pressure variation width of the hydrogen supply pressure is set to the second reference width and the supply flow rate acceleration of hydrogen supplied to the fuel cell stack 110 is set to the second acceleration, and, as such, may control the hydrogen supply pressure.

If the re-determined internal resistance is not less than the predetermined second reference internal resistance, the controller 130 determines that a state change from the flooded state to the dry state has occurred in the fuel cell stack 110. The controller 130 may control the hydrogen supply pressure by activating a second pressure control function for momentarily varying a pressure in accordance with the dry state. If water present in the fuel cell stack 110 is drained in the dry state of the fuel cell stack 110, the dry state may become severe, thereby resulting in degradation of the fuel cell stack 110. To this end, if the fuel cell stack 110 is in the dry state, the second pressure control function for momentarily varying a pressure without draining water from the interior of the fuel cell stack 110 may be executed in order to increase the amount of the water remaining in the interior of the fuel cell stack 110.

If the second pressure control function is activated, the controller 130 may control the hydrogen supply pressure by setting the pressure variation width of the hydrogen supply pressure to a third reference width. If the second pressure control function is activated, control of the hydrogen supply pressure as described above with reference to FIG. 2 may be performed. The third reference width may be smaller than the first reference width and the second reference width set in accordance with activation of the first pressure control function. This is only illustrative and, as such, the present disclosure is not limited thereto.

If the second pressure control function is activated, the controller 130 may control the hydrogen supply pressure such that a pressure variation is carried out within a short time by setting the pressure variation width to the third reference width, as described above with reference to FIG. 2.

Also, or alternatively, in determining a state of the fuel cell stack 110 based on a result of comparison between the drained water amount and the required drain amount and/or a result of comparison between the internal resistance of the fuel cell stack 110 and the predetermined first reference internal resistance, the controller 130 may determine that the fuel cell stack 110 is in the dry state, if the drained water amount according to opening of the drain valve 120 is not less than the required drain amount, or the internal resistance of the fuel cell stack 110 is less than the first reference internal resistance. The controller 130 may activate the second pressure control function according to the dry state, thereby controlling the hydrogen supply pressure.

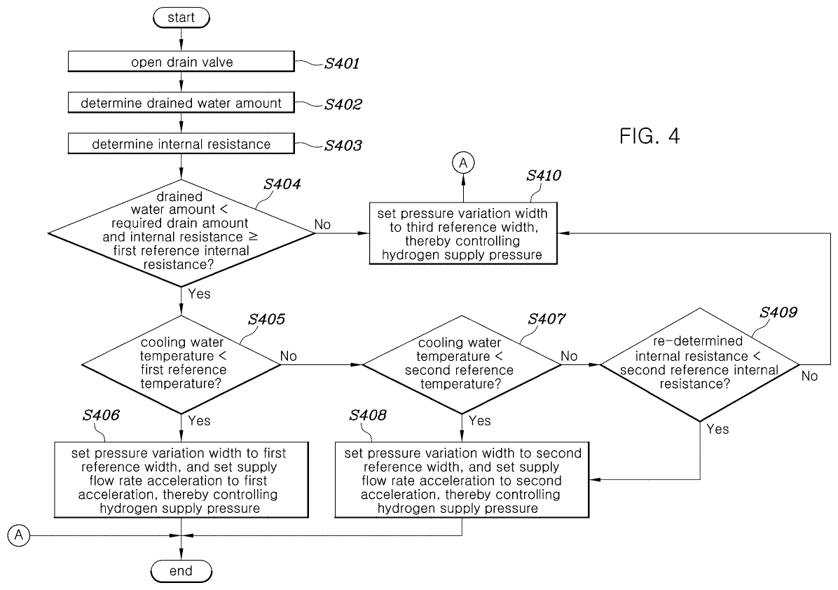

Hereinafter, a control method of a fuel cell system according to an example of the present disclosure based on the fuel cell system described with reference to FIG. 1 will be described with reference to FIG. 4. For a detailed description of each step of the control method of the fuel cell system according to the example of the present disclosure, reference may be made to the description given with reference to FIG. 1 and, as such, may be omitted or briefly given.

FIG. 4 is a flowchart explaining the control method of the fuel cell system according to the example of the present disclosure.

Referring to FIG. 4, the controller 130 may outwardly drain water present at the anode side of the fuel cell stack 110 by opening the drain valve 120 (S401).

Thereafter, the controller 130 may determine an amount of water drained from the fuel cell stack 110 according to opening of the drain valve 120 (S402), and may determine an internal resistance of the fuel cell stack 110 after drain of water (S403).

The controller 130 may compare the determined drained water amount with a predetermined required drain amount and may compare the determined internal resistance with a predetermined first reference internal resistance, thereby determining a state of the fuel cell stack 110 (S404).

If the drained water amount is less than the predetermined required drainage amount and the internal resistance is not less than the predetermined reference internal resistance (Yes in S404), the controller 130 may determine that the fuel cell stack 110 is in a flooded state. If the fuel cell stack 110 is in the flooded state, the controller 130 may control a hydrogen supply pressure by activating a first pressure control function for stepwise varying a pressure such that a pressure variation maintenance time according to a pressure variation is given. The controller 130 may determine a temperature of cooling water discharged from the fuel cell stack 110 (S405 and S407), thereby differentially controlling the hydrogen supply pressure in accordance with a temperature of the cooling water.

For example, if the temperature of the cooling water discharged from the fuel cell stack 110 is less than a predetermined first reference temperature (Yes in S405), the controller 130 may set a first control condition that a pressure variation width of the hydrogen supply pressure is set to a first reference width and a supply flow rate acceleration of hydrogen supplied to the fuel cell stack 10 is set to a first acceleration, thereby controlling the hydrogen supply pressure (S406).

If the temperature of the cooling water discharged from the fuel cell stack 110 is not less than the predetermined first reference temperature, but less than a predetermined second reference temperature higher than the first reference temperature (No in S405 and Yes in S407), the controller 130 may set a second control condition that the pressure variation width of the hydrogen supply pressure is set to a second reference width and the supply flow rate acceleration of the hydrogen supplied to the fuel cell stack 110 is set to a second acceleration, thereby controlling the hydrogen supply pressure (S408).

If the temperature of the cooling water discharged from the fuel cell stack 110 is not less than the predetermined second reference temperature (No in S407), the controller 130 may re-determine an internal resistance of the fuel cell stack 110, and may compare the re-determined internal resistance with a predetermined second reference internal resistance, thereby determining whether or not a state change of the fuel cell stack 110 from the flooded state to a dry state has occurred (S409).

If the re-determined internal resistance is less than the predetermined second reference internal resistance (Yes in S409), the controller 130 may determine that no state change of the fuel cell stack 110 has occurred, and may then set the above-described second control condition, thereby controlling the hydrogen supply pressure (S408).

If the re-determined internal resistance is not less than the predetermined second reference internal resistance (No in S409), the controller 130 may determine that the fuel cell stack 110 is in the dry state in accordance with occurrence of a state change thereof, and may then control the hydrogen supply pressure in accordance with results of the determination. For example, upon determining that the fuel cell stack is in the dry state (No in S404 or No in S409), the controller 130 may control the hydrogen supply pressure by activating a second pressure control function for momentarily varying a pressure and setting the pressure variation width of the hydrogen supply pressure to a third reference width (S410).

Therefore, the present disclosure has been made in view of the above problems, and it is an object of the present disclosure to provide a fuel cell system and a control method thereof which are capable of enhancing drainage of water present in a fuel cell stack.

Objects of the present disclosure are not limited to the above-described objects, and other objects of the present disclosure not yet described will be more clearly understood by those skilled in the art from the following detailed description.

In accordance with an aspect of the present disclosure, the above and other objects can be accomplished by the provision of a fuel cell system including a fuel cell stack, a drain valve connected to a side of an anode of the fuel cell stack, and a controller configured to determine a drained water amount at the anode side of the fuel cell stack according to opening of the drain valve, and control a hydrogen supply pressure supplied to the fuel cell stack by activating different pressure control functions in accordance with a result of comparison between the drained water amount and a predetermined required drain amount.

For example, the controller may be configured to further determine an internal resistance of the fuel cell stack, to determine a state of the fuel cell stack based on the result of the comparison between the drained water amount and the required drain amount and a result of comparison between the determined internal resistance and a predetermined first reference internal resistance, and control the hydrogen supply pressure by activating the different pressure control functions in accordance with the determined state of the fuel cell stack.

For example, the controller may determine that the fuel cell stack is in a flooded state, when the drain water amount is less than the required drainage amount and the internal resistance is not less than the first reference internal resistance, and may control the hydrogen supply pressure by activating a first pressure control function for stepwise varying a pressure such that a pressure variation maintenance time according to a pressure variation is given, when the fuel cell stack is in the flooded state.

For example, the controller may determine a temperature of cooling water discharged from the fuel cell stack, when the first pressure control function is activated, and may control the hydrogen supply pressure by differentially setting a control condition according to the activation of the first pressure control function, based on the determined temperature of the cooling water.

For example, when the temperature of the cooling water is less than a predetermined first reference temperature, the controller may control the hydrogen supply pressure by setting a pressure variation width of the hydrogen supply pressure to a first reference width, and setting a supply flow rate acceleration of hydrogen supplied to the fuel cell stack to a first acceleration.

For example, when the temperature of the cooling water is not less than the predetermined first reference temperature, but less than a predetermined second reference temperature higher than the predetermined first reference temperature, the controller may control the hydrogen supply pressure by setting the pressure variation width of the hydrogen supply pressure to a second reference width, and setting the supply flow rate acceleration of the hydrogen supplied to the fuel cell stack to a second acceleration.

For example, the controller may determine whether or not a state change of the fuel cell stack from the flooded state to a dry state caused by overheat has occurred, when the temperature of the cooling water is not less than the predetermined second reference temperature, and may control the hydrogen supply pressure by setting the pressure variation width of the hydrogen supply pressure to a second reference width and setting the supply flow rate acceleration of hydrogen supplied to the fuel cell stack to a second acceleration when the state change has not occurred.

For example, the controller may re-determine the internal resistance of the fuel cell stack when the temperature of the cooling water is not less than the predetermined second reference temperature, and may determine that the state change of the fuel cell stack has occurred, when the re-determined internal resistance is not less than a predetermined second reference internal resistance.

For example, the controller may determine that the fuel cell stack is in the dry state, when the drained water amount is not less than the required drain amount or the determined internal resistance is less than the first reference internal resistance, and may control the hydrogen supply pressure by activating a second pressure control function for momentarily varying a pressure, upon determining that the fuel cell is in the dry state.

For example, when the second pressure control function is activated, the controller may control the hydrogen supply pressure by setting the pressure variation width of the hydrogen supply pressure to a third reference width.

Further, in accordance with another aspect of the present disclosure, there is provided a control method of a fuel cell system including determining a drained water amount at a side of an anode of a fuel cell stack according to opening of a drain valve connected to the anode side of the fuel cell stack, comparing the drained water amount with a predetermined required drain amount, and controlling a hydrogen supply pressure supplied to the fuel cell stack by activating different pressure control functions in accordance with a result of the comparison between the drained water amount and the required drain amount.

For example, before the controlling, the control method may further include determining an internal resistance of the fuel cell stack and comparing the determined internal resistance with a predetermined first reference internal resistance.

For example, the controlling may include determining a state of the fuel cell stack based on the result of the comparison between the drained water amount and the required drain amount and a result of the comparison between the determined internal resistance and the predetermined first reference internal resistance, and controlling the hydrogen supply pressure by activating the different pressure control functions in accordance with the determined state of the fuel cell stack.

For example, the controlling may further include determining that the fuel cell stack is in a flooded state, when the drain water amount is less than the required drain amount and the internal resistance is not less than the first reference internal resistance, and controlling the hydrogen supply pressure by activating a first pressure control function for stepwise varying a pressure such that a pressure variation maintenance time according to a pressure variation is given, when the fuel cell stack is in the flooded state.

For example, the controlling may further include determining a temperature of cooling water discharged from the fuel cell stack, when the first pressure control function is activated, and controlling the hydrogen supply pressure by differentially setting a control condition according to the activation of the first pressure control function, based on the determined temperature of the cooling water.

For example, the controlling may further include determining that the fuel cell stack is in a dry state, when the drained water amount is not less than the required drain amount or the determined internal resistance is less than the first reference internal resistance, and controlling the hydrogen supply pressure by activating a second pressure control function for momentarily varying a pressure, upon determining that the fuel cell stack is in the dry state.

In accordance with the present disclosure as described above, the following effects may be provided. That is, the fuel cell system and the control method according to the present disclosure may control a hydrogen supply pressure when water in the interior of the fuel cell stack is required to be additionally drained such that a flow rate of hydrogen supplied to the fuel cell stack is increased, thereby achieving an enhancement in water drain capacity.

As disclosed herein, it may be possible to not only achieve an enhancement in water drain capacity, but also to minimize airflow sound caused by introduction of hydrogen by stepwise varying a pressure such that a pressure variation maintenance time according to a pressure variation is given to cope with a rapid pressure variation occurring during control of the hydrogen supply pressure.

Effects attainable by the present disclosure are not limited to the above-described effects, and other effects of the present disclosure not yet described will be more clearly understood by those skilled in the art from the following detailed description.

As apparent from the above description, the fuel cell system and the control method according to the present disclosure may control a hydrogen supply pressure if water in the interior of the fuel cell stack is required to be additionally drained such that a flow rate of hydrogen supplied to the fuel cell stack is increased, thereby achieving an enhancement in water drain capacity.

Also, or alternatively, it may be possible to not only achieve an enhancement in water drain capacity, but also to minimize airflow sound caused by introduction of hydrogen by stepwise varying a pressure such that a pressure variation maintenance time according to a pressure variation is given to cope with a rapid pressure variation occurring during control of the hydrogen supply pressure.

Although the preferred examples of the present disclosure have been disclosed for illustrative purposes, those skilled in the art will appreciate that various modifications, additions and substitutions are possible, without departing from the scope and spirit of the disclosure as disclosed in the accompanying claims.

Furthermore, the term related to a control device such as “controller”, “control apparatus”, “control unit”, “control device”, “control module”, or “server”, etc. refers to a hardware device including a memory and a processor configured to execute one or more steps interpreted as an algorithm structure. The memory stores algorithm steps, and the processor executes the algorithm steps to perform one or more processes of a method in accordance with various examples of the present disclosure. The control device according to examples of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured to process data according to a program provided from the memory, and may be configured to generate a control signal according to the processing result.

The control device may be at least one microprocessor operated by a predetermined program which may include a series of commands for carrying out the method included in the aforementioned various examples of the present disclosure.

The aforementioned disclosure can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc. and implementation as carrier waves (e.g., transmission over the Internet). Examples of the program instruction include machine language code such as those generated by a compiler, as well as high-level language code which may be executed by a computer using an interpreter or the like.

In various examples of the present disclosure, each operation described above may be performed by a control device, and the control device may be configured by a plurality of control devices, or an integrated single control device.

In various examples of the present disclosure, the memory and the processor may be provided as one chip, or provided as separate chips.

In various examples of the present disclosure, the scope of the present disclosure includes software or machine-executable commands (e.g., an operating system, an application, firmware, a program, etc.) for enabling operations according to the methods of various examples to be executed on an apparatus or a computer, a non-transitory computer-readable medium including such software or commands stored thereon and executable on the apparatus or the computer.

In various examples of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the examples with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In examples of the present disclosure, “at least one of A and B” may refer to “at least one of A or B” or “at least one of combinations of one or more of A and B”. Also, or alternatively, “one or more of A and B” may refer to “one or more of A or B” or “one or more of combinations of one or more of A and B”.

In the example of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific examples of the present disclosure have been presented for purposes of illustration and description. They are not intended to be exhaustive or to limit the present disclosure to the precise forms disclosed, and obviously many modifications and variations are possible in light of the above teachings. The examples were chosen and described in order to explain certain principles of the disclosure and their practical application, to enable others skilled in the art to make and utilize various examples of the present disclosure, as well as various alternatives and modifications thereof. It is intended that the scope of the present disclosure be defined by the claims appended hereto and their equivalents.

What is claimed is:

1. A fuel cell system comprising:
a fuel cell stack;
a drain valve connected to an anode of the fuel cell stack; and
a controller configured to:
determine a drained water amount of water drained, via an opening of the drain valve, from the anode of the fuel cell stack; and
control, by activating, based on a comparison between the drained water amount and a predetermined required drain amount, one or more pressure control functions, a hydrogen supply pressure to the fuel cell stack.

2. The fuel cell system of claim 1, wherein the controller is further configured to:
determine an internal resistance of the fuel cell stack;
determine, based on the comparison between the drained water amount and the required drain amount and based on a comparison between the determined internal resistance and a predetermined first reference internal resistance, a state of the fuel cell stack; and
control, by activating, further based on the determined state of the fuel cell stack, the one or more pressure control functions, the hydrogen supply pressure.

3. The fuel cell system of claim 2, wherein the controller is further configured to:
determine, based on the drained water amount being less than the required drain amount and the internal resistance being greater than or equal to the first reference internal resistance, that the fuel cell stack is in a flooded state; and
control, based on the fuel cell stack being in the flooded state, the hydrogen supply pressure by activating a first pressure control function, of the one or more pressure control functions, that changes a pressure in stages that each last a pressure variation maintenance time.

4. The fuel cell system of claim 3, wherein the controller is further configured to:
determine, based on the first pressure control function being activated, a temperature of cooling water discharged from the fuel cell stack; and
control the hydrogen supply pressure by differentially setting, based on the determined temperature of the cooling water, a control condition according to the activation of the first pressure control function.

5. The fuel cell system of claim 4, wherein the controller is configured to, based on the temperature of the cooling water being less than a first reference temperature, control the hydrogen supply pressure by setting a pressure variation width of the hydrogen supply pressure to a first reference width and setting a supply flow rate acceleration of hydrogen supplied to the fuel cell stack to a first acceleration.

6. The fuel cell system of claim 4, wherein the controller is configured to, based on the temperature of the cooling water being greater than or equal to a first reference temperature and less than a second reference temperature, control the hydrogen supply pressure by setting a pressure variation width of the hydrogen supply pressure to a second reference width, and setting a supply flow rate acceleration of hydrogen supplied to the fuel cell stack to a second acceleration.

7. The fuel cell system of claim 4, wherein the controller is further configured to:
determine, based on the temperature of the cooling water being equal to or greater than a second reference temperature, that a state change of the fuel cell stack from the flooded state to a dry state has not occurred; and
control, based on the state change having not occurred, the hydrogen supply pressure by setting a pressure variation width of the hydrogen supply pressure to a second reference width and setting a supply flow rate acceleration of hydrogen supplied to the fuel cell stack to a second acceleration.

8. The fuel cell system of claim 7, wherein the controller is further configured to:
re-determine, based on the temperature of the cooling water being equal to or greater than the second reference temperature, the internal resistance of the fuel cell stack; and
determine, based on the re-determined internal resistance being equal to or greater than a second reference internal resistance, that the state change of the fuel cell stack has occurred.

9. The fuel cell system of claim 2, wherein the controller is further configured to:
determine, based on the drained water amount being equal to or greater than the required drain amount or the determined internal resistance being less than the first reference internal resistance, that the fuel cell stack is in a dry state; and
control the hydrogen supply pressure by activating, based on the fuel cell stack being in the dry state, a second pressure control function, of the one or more pressure control functions, for momentarily varying a pressure.

10. The fuel cell system of claim 9, wherein the controller is configured to, based on the second pressure control function being activated, control the hydrogen supply pressure by setting a pressure variation width of the hydrogen supply pressure to a third reference width.

11. A control method of a fuel cell system comprising:
determining a drained water amount of water drained from an anode side of a fuel cell stack;
comparing the drained water amount with a predetermined required drain amount; and
controlling, by activating, based on the comparing the drained water amount with the required drain amount, one or more pressure control functions, a hydrogen supply pressure supplied to the fuel cell stack.

12. The control method of claim 11, further comprising:
determining an internal resistance of the fuel cell stack; and
comparing the determined internal resistance with a predetermined first reference internal resistance.

13. The control method of claim 12, further comprising:
determining, based on the comparing the drained water amount with the required drain amount and the comparing the determined internal resistance with the predetermined first reference internal resistance, a state of the fuel cell stack; and
controlling, by activating, based on the determined state of the fuel cell stack, the one or more pressure control functions, the hydrogen supply pressure.

14. The control method of claim 13, further comprising:
determining, based on the drain water amount being less than the required drain amount and the internal resistance being equal to or greater than the first reference internal resistance, that the fuel cell stack is in a flooded state; and
controlling, based on the fuel cell stack being in the flooded state, the hydrogen supply pressure by activating a first pressure control function, of the one or more pressure control functions, that changes a pressure in stages that each last a pressure variation maintenance time.

15. The control method of claim 14, further comprising:
determining, based on the first pressure control function being activated, a temperature of cooling water discharged from the fuel cell stack; and
controlling the hydrogen supply pressure by differentially setting, based on the determined temperature of the cooling water, a control condition according to the activation of the first pressure control function.

16. The control method of claim 13, further comprising:
determining, based on the drained water amount being equal to or greater than the required drain amount or the determined internal resistance being less than the first reference internal resistance, that the fuel cell stack is in a dry state; and
controlling the hydrogen supply pressure by activating, based on the fuel cell stack being in the dry state, a second pressure control function for momentarily varying a pressure.
